(19) United States
(12) Patent Application Publication
(10) Pub. No.: US 2009/0034158 A1
(43) Pub. Date: Feb. 5, 2009

(54) Electric Double Layer Capacitor

(75) Inventor: Tomokazu Sasaki, Tokyo (JP)

Correspondence Address: BIRCH STEWART KOLASCH & BIRCH, PO BOX 747, FALLS CHURCH, VA, 22040-0747, US

(73) Assignee: ZEON CORPORATION, Tokyo (JP)

(21) Appl. No.: 12/086,772

(22) PCT Filed: Dec. 19, 2006
(86) PCT No.: PCT/JP2006/325259

§ 371 Date: Jun. 19, 2008

(30) Foreign Application Priority Data
Dec. 20, 2005 (JP) 2005-366840

(51) Int. Cl. H01G 9/00

(52) U.S. Cl. 361/502

(57) ABSTRACT

An electric double layer capacitor containing a capacitor element comprised of electrodes including a pair of polarizable electrodes facing each other across a separator and an electrolytic solution, wherein at least one of the polarizable electrodes has a density of 0.40 to 0.59 g/cm³, and said electrolytic solution contains an ionic liquid. Here, the polarizable electrodes are preferably comprised an electrode active substance and conductive material bonded by a binder to form composite particles which are in turn bonded together.

### TECHNICAL FIELD

The present invention relates to an electric double layer capacitor. More particularly, it relates to an electric double layer capacitor superior in the permeability of an ionic liquid of the electrolytic solution, high in productivity, and small in internal resistance.

### BACKGROUND ART

Electric double layer capacitors are devices which are large in current, can be rapidly charged and discharged, have little loss at the time of charging and discharging, have remarkably long cycle lives, and are suitable for energy saving. Recently, large sized products have been developed. Application as secondary power sources for electric vehicles, hybrid cars, and fuel cell vehicles may be expected.

The electrolytic solution of an electric double layer capacitor requires, as basic performances, a high electrical conductivity, decomposition voltage, and electric double layer capacity, and also a wide range of usage temperature. The conventional electrolytic solutions using solid ammonium salts as solutes have the problems of a low charging and discharging efficiency in the low temperature and high temperature region, a smaller energy density than secondary cells, etc. As opposed to this, when using an ionic liquid as an electrolyte, the safety is high, the electrolyte is electrochemically stable, the heat resistance is superior, and the electric double layer capacity is also large, so improvement of the drive voltage can be expected. However, in an electrolytic solution containing an ionic liquid, there was the problem that the electrolytic solution was high in viscosity and the electrolytic solution had trouble permeating the electrodes.

To improve the permeability of the electrolytic solution in the electrodes, it has been proposed to use electrodes containing activated carbon fibers having lyophilic functional groups for the electrolytic solution (see Japanese Patent Publication (A) No. 2005-268316).

### DISCLOSURE OF THE INVENTION

However, with this method, the effect of improvement of the permeability for high viscosity ionic liquids was insufficient.

The inventor of the present invention had as their object the provision of an electric double layer capacitor using electrodes with a high permeability of an ionic liquid of an electrolytic solution, with a low internal resistance, and able to be produced with a high productivity.

The inventor engaged in intensive studies on the factors governing the permeability of ionic liquids and as a result discovered that the density of a polarizable electrode has a great effect on the permeability of the ionic liquid. Further, the inventor discovered that conventional polarizable electrodes are high in density and take note of only improvement of the lyophilicity of the surface, so sometimes ionic liquid does not sufficiently permeate to the inside, the productivity is low, and as a result the obtained electric double layer capacitor becomes high in internal resistance. As opposed to this, the inventor discovered that the above problems could be solved by using an electric double layer capacitor having polarizable electrodes with densities in a specific range and preferably with an electrode active substance and a conductive material bonded by a binder to form composite particles which in turn are mutually bonded, and completed the present invention based on these discoveries.

According to the present invention, there is provided an electric double layer capacitor containing a capacitor element comprised of electrodes including a pair of polarizable electrodes facing each other across a separator and an electrolytic solution, wherein at least one of the polarizable electrodes has a density of 0.40 to 0.59 g/cm³, and the electrolytic solution contains an ionic liquid.

In the present invention, preferably the polarizable electrodes are produced by using both a small size electrode active substance with a volume average particle size of 2 to 6 μm and a large size electrode active substance with a volume average particle size of 8 to 20 μm.

Further, in the present invention, preferably the polarizable electrodes contain palm shell carbon as electrode active substances.

Further, in the present invention, preferably the polarizable electrodes are comprised of an electrode active substance and conductive material bonded by a binder to form composite particles which are in turn bonded together.

Further, in the present invention, preferably the composite particles are produced by a spray dry granulation method having a step of obtaining a slurry A containing an electrode active substance, conductive material, and binder and a step of spray drying the slurry A.

Further, in the present invention, preferably the polarizable electrodes are produced by roll press forming the composite particles.

Further, in the present invention, preferably the electrode is comprised of a polarizable electrode laminated with a current collector via a layer of a conductive adhesive.

### BRIEF DESCRIPTION OF THE DRAWINGS

FIG. 1 is a cross-sectional view showing an example of a composite particle suitably used for the present invention,

FIG. 2 is a view showing a cross-section of an electrode suitable used for the present invention, and

FIG. 3 is a view showing an example of a spray drying system used in an embodiment.

### BEST MODE FOR CARRYING OUT THE INVENTION

The electric double layer capacitor of the present invention is characterized by containing a capacitor element comprised of electrodes including a pair of polarizable electrodes facing each other across a separator and an electrolytic solution, wherein at least one of the polarizable electrodes has a density of 0.40 to 0.59 g/cm³, and the electrolytic solution contains an ionic liquid.

(Electrode Active Substance)

Each polarizable electrode contains, as essential ingredients, an electrode active substance and binder. As the electrode active substance, usually a carbon allotrope is used. The electrode active substance is preferably one of a large specific surface area enabling the formation of a wide area interface even with the same weight. Specifically, the specific surface area is 30 m²/g or more, preferably 500 to 5,000 m²/g, more preferably 1,000 to 3,000 m²/g. The larger the electrode active substance used in specific surface area, the smaller the polarizable electrode obtained tends to be in density, so by suitably selecting the electrode active substance, it is possible to obtain a polarizable electrode having the desired density. As specific examples of carbon allotropes, activated carbon, polyacene, carbon whiskers, graphite, etc. may be mentioned. Powders or fibers of these may be used. The preferable electrode active substance is activated carbon. Specifically, as materials of the activated carbon, phenolic resin, rayon, acrylonitrile resin, pitch, and palm shell etc. may be mentioned.

Further, it is possible to use nonporous carbon having graphite-like microcrystalline carbon and having an enlarged distance between layers of microcrystalline carbon as the electrode active substance. Such nonporous carbon is obtained by dry distilling graphitizable carbon with developed microcrystals of a multilayer graphite structure at 700 to 850° C., then heat treating this together with caustic alkali at 800 to 900° C. and removing the residual alkali ingredients by heated steam etc. in accordance with need.

The electrode active substance has a volume average particle size of usually 0.1 to 100 μm, preferably 1 to 50 μm, more preferably 5 to 20 μm. The larger the electrode active substance used in volume average particle size, the lower the polarizable electrode obtained in density, so by suitably selecting the electrode active substance, it is possible to obtain a polarizable electrode having the desired density.

These electrode active substances may be used alone or in any combinations of two or more types. When using carbon allotropes in combination, it is preferable to use a combination of two or more types of carbon allotropes differing in volume average particle size. Jointly using a small size electrode active substance with a volume average particle size of 2 to 6 μm and a large size electrode active substance with a volume average particle size of 8 to 20 μm is particularly preferable. If jointly using a small size electrode active substance and a large size electrode active substance, it is possible to adjust the density of the polarizable electrode obtained by this mixture ratio. The ratio in the case of jointly using a small size electrode active substance and a large size electrode active substance is, by weight ratio, preferably 90:10 to 10:90, more preferably 20:80 to 80:20. Further, if at least one of the small size electrode active substance or large size electrode active substance is activated carbon made from palm shells (palm shell carbon), the permeability of the ionic liquid is superior, so this is particularly preferable.

(Binder)

The binder is not particularly limited so long as it is a compound enabling the particles of the electrode active substance to be bonded with each other. A suitable binder is a dispersion type binder of a nature dispersing in a solvent. As a dispersion type binder, for example a fluorine-based polymer, diene-based polymer, acrylate-based polymer, polyimide, polyamide, polyurethane-based polymer, or other polymer compound may be mentioned, more preferably, a fluorine-based polymer, diene-based polymer, and acrylate-based polymer may be mentioned. These binders may be used alone or in combinations of two or more types.

A fluorine-based polymer is a polymer containing monomer units containing fluorine atoms. The ratio of the monomer units containing fluorine in the fluorine-based polymer is usually 50 wt % or more. As specific examples of a fluorine-based polymer, polytetrafluoroethylene, polyvinylidene fluoride, or other fluorine resin may be mentioned, while polytetrafluoroethylene is preferable.

The diene-based polymer is a polymer containing butadiene-, isoprene-, or other conjugated diene-derived monomer units and their, hydrogenates. The ratio of the conjugated diene-derived monomer units in the diene-based polymer is usually 40 wt % or more, preferably 50 wt % or more, more preferably 60 wt % or more. Specifically, polybutadiene, polyisoprene, or other conjugated diene homopolymers; a carboxy-modified or unmodified styrene-butadiene copolymer (SBR) or other aromatic vinyl-conjugated diene copolymers; an acrylonitrile-butadiene copolymer (NBR) or other vinyl cyanide-conjugated diene copolymers; hydrogenated SBR, hydrogenated NBR, etc. may be mentioned.

The acrylate-based polymer is a polymer containing acrylic acid ester- and/or methacrylic acid ester-derived monomer units. The ratio of the acrylic acid ester- and/or methacrylic acid ester-derived monomer units in the acrylate-based polymer is usually 40 wt % or more, preferably 50 wt % or more, more preferably 60 wt % or more. As specific examples of an acrylate-based polymer, 2-ethylhexyl acrylate-methacrylic acid-acrylonitrile-ethylene glycol dimethacrylate copolymer, 2-ethylhexyl acrylate-methacrylic acid-methacrylonitrile-diethylene glycol dimethacrylate copolymer, 2-ethylhexyl acrylate-styrene-methacrylic acid-ethylene glycol dimethacrylate copolymer, butyl acrylate-acrylonitrile-diethylene glycol dimethacrylate copolymer, and butyl acrylate-acrylic acid-trimethylolpropane trimethacrylate copolymer, and other cross-linkable acrylate-based polymers; ethylene-methyl acrylate copolymer, ethylene-methyl methacrylate copolymer, ethylene-ethyl acrylate copolymer, ethylene-ethyl methacrylate copolymer, and other copolymers of ethylene and acrylic acid (or methacrylic acid) esters; graft polymers comprised of copolymers of the ethylene and acrylic acid (or methacrylic acid) esters on which radical polymerizable monomers are grafted; etc. may be mentioned. Note that as the radical polymerizable monomer used for the graft polymer, for example, methyl methacrylate, acrylonitrile, methacrylic acid, etc. may be mentioned. In addition, ethylene-acrylic acid copolymers, ethylene-methacrylic acid copolymers, etc. may be used as a binder.

Among these, from the viewpoint that a polarizable electrode superior in bondability with a current collector or surface flatness is obtained and, further, an electric double layer capacitor with a high capacity and low internal resistance can be produced, a diene-based polymer and cross-linkable acrylate-based polymer is preferable and a cross-linkable acrylate-based polymer is particularly preferable.

The binder used in the present invention is not particularly limited by shape, but granular particles are preferable since the bondability is good and further a drop in capacity of the prepared electrode or degradation due to repeated charging and discharging can be suppressed. As a granular binder, for example, one like a latex in the state with the granular particles of the binder dispersed in water or one of a powder form obtained by drying such a dispersion may be mentioned.

Further, the binder used for the present invention may be granular particles having a core-shell structure obtained by step by step polymerization of two or more types of monomer mixtures. The binder having a core-shell structure is preferably produced by first polymerizing the monomer giving a first stage polymer to obtain seed particles, then polymerizing the monomer giving a second stage polymer in the presence of these seed particles.

The ratio of the core and shell of the binder having the core-shell structure is not particularly limited, but by weight ratio is a core part:shell part of usually 50:50 to 99:1, preferably 60:40 to 99:1, more preferably 70:30 to 99:1. The polymer compounds forming the core part and the shell part may be selected from the above polymer compounds. The core part and shell part preferably on the one hand has a glass transition temperature of less than 0° C., while on the other hand have a glass transition temperature of 0° C. or more. Further, the difference between the glass transition temperatures of the core part and shell part is usually 20° C. or more, preferably 50° C. or more.

The granular particle binder used for the present invention is not particularly limited by the number average particle size, but usually has a number average particle size of 0.0001 to 100 μm, preferably 0.001 to 10 μm, more preferably 0.01 to 1 μm. When the binder has a number average particle size in this range, it is possible to give a superior bonding force to the polarizable electrode even with use of a small amount of binder. Here, the number average particle size is the number average particle size calculated by measuring the sizes of 100 binder particles randomly selected from a transmission type electron microscope photograph and calculating the arithmetic average. The granular particles may be either spherical or irregularly shaped.

The amount of the binder used in the present invention is usually 0.1 to 50 parts by weight with respect to 100 parts by weight of the electrode active substance, preferably 0.5 to 20 parts by weight, more preferably 1 to 10 parts by weight.

The polarizable electrode may contain as optional ingredients a conductive material, dispersant, and other additives. The conductive material is comprised of a granular particle shaped carbon allotrope having conductivity and not having fine pores able to form an electric double layer and improves the conductivity of the polarizable electrode. The conductive material preferably has a volume average particle size smaller than the volume average particle size of the electrode active substance. The range is usually 0.001 to 10 μm, preferably 0.05 to 5 μm, more preferably 0.01 to 1 μm. If the conductive material has a volume average particle size in this range, a high conductivity can be obtained by a smaller amount of use. Specifically, furnace black, acetylene black, Ketjen Black (registered trademark of Akzo Nobel Chemicals BV), and other conductive carbon black and natural graphite, artificial graphite, and other graphite may be mentioned. Among these, conductive carbon black is preferable, while acetylene black and furnace black are more preferable. These conductive materials may be used alone or in combinations of two or more types.

The amount of the conductive material is usually 0.1 to 50 parts by weight with respect to 100 parts by weight of the electrode active substance, preferably 0.5 to 15 parts by weight, more preferably 1 to 10 parts by weight. If the amount of the conductive material is in this range, the electric double layer capacitor using the obtained polarizable electrode is high in capacity and can be made lower in the internal resistance. Further, the greater the amount of the conductive material, the lower the polarizable electrode obtained in density. The amount of the conductive material can be used to adjust the density of the polarizable electrode obtained.

The dispersant is a resin dissolving in a solvent. It is preferably used dissolved in a solvent at the time of preparation of the later explained slurry A, B, or C and has the action of causing uniform dispersion of the electrode active substance, conductive material, etc. in the solvent. As specific examples of dispersants, carboxymethyl cellulose, methyl cellulose, ethyl cellulose, hydroxypropyl cellulose, and other cellulose-based polymers and their ammonium salts or alkali metal salts; sodium polyacrylate (or polymethacrylate) and other polyacrylates (or polymethacrylates); polyvinyl alcohol, modified polyvinyl alcohol, polyethylene oxide; polyvinyl pyrrolidone, polycarboxylic acid, starch oxide, starch phosphate, casein, various types of modified starch, chitin, chitosan derivatives etc. may be mentioned. These dispersants may be used alone or in combinations of two or more types. Among these, cellulose-type polymers are preferable, while carboxymethyl cellulose or its ammonium salt or alkali metal salts are particularly preferable.

The amount of the dispersant used is not particularly limited, but is usually 0.1 to 10 parts by weight with respect to 100 parts by weight of the electrode active substance, preferably 0.5 to 5 parts by weight, more preferably 0.8 to 2 parts by weight in range. By using a dispersant, it is possible to suppress the precipitation or agglomeration of the solids in the slurry A, B, or C. Further, the larger the amount of the dispersant used, the higher the slurry A, B, or C in viscosity. The higher the slurry A, B, or C in viscosity, the higher the polarizable electrode in density, so the amount of the dispersant used can be used to adjust the obtained polarizable electrode in density.

As another additive, for example, there is a surfactant. The surfactant preferably is contained in the composite particles. As the surfactant, anionic, cationic, nonionic, and nonionic anionic and other amphoteric surfactants may be mentioned. Among these, an anionic or nonionic surfactant which easily breaks down under heat is preferable. The amount of the surfactant is not particularly limited, but is 0 to 50 parts by weight with respect to 100 parts by weight of the electrode active substance, preferably 0.1 to 10 parts by weight, more preferably 0.5 to 5 parts by weight in range.

The polarizable electrode has a density (hereinafter sometimes referred to as an “electrode density”) of 0.40 to 0.59 g/cm³, preferably 0.45 to 0.57 g/cm³, more preferably 0.50 to 0.55 g/cm³. If the electrode density is in this range, it is possible to achieve both a short permeation time of the electrolytic solution and a high electrostatic capacity of the obtained electric double layer capacitor. If the electrode density is too low, the capacity per volume of the electric double layer capacitor becomes lower. On the other hand, if the electrode density is too high, the electrolytic solution is low in permeability and the time required for production of the electric double layer capacitor becomes longer, so the productivity falls.

The polarizable electrode also differs in thickness due to the shape or application of the electric double layer capacitor, but usually is 50 to 2,000 μm or so. From the viewpoint of making the capacity per unit volume larger, thicker is better. From the viewpoint of obtaining a large current, thinner is better. When the electric double layer capacitor is a button type or rectangular prism type, the polarizable electrode preferably has a thickness of 200 to 1,000 μm, more preferably 300 to 700 μm. Further, when the electric double layer capacitor is a cylindrical shape, the polarizable electrode preferably has a thickness of 30 to 400 μm, more preferably 150 to 300 μm. If the polarizable electrode is too thick, when cut, wound, etc. in accordance with the shape of the electric double layer capacitor, the polarizable electrode is liable to break or peel. On the other hand, if the polarizable electrode is too thin, the capacity per unit volume of the electric double layer capacitor is low.

(Dry Forming)

The polarizable electrode is obtained by forming the electrode active substance, binder and conductive material and other ingredients used in accordance with need and/or later mentioned composite particles (below referred to all together as “electrode materials”) into a sheet. The forming method is not particularly limited so long as the electrode density becomes one in the above range. For example, there is the press forming method or other dry forming methods and the coating method or other wet forming methods. The dry forming method is preferable in that it does not require any drying step and enables the production costs to be suppressed.

The dry forming method is not particularly limited. Specifically, press forming by applying pressure to the electrode materials so as to make it denser by the rearrangement and deformation of the electrode materials and form the polarizable electrode; extrusion continuously forming a polarizable electrode as a film, sheet, or other endless long article—also called “paste extrusion” since the electrode materials are in a paste state when extruded from the press machine; etc. may be mentioned. Among these, press forming is preferably used since simple facilities are enough.

As the press forming, for example, there are the roll press forming method of supplying the electrode materials by a screw feeder or other feeder to a roll type press forming apparatus to form the polarizable electrode, the method of spreading the electrode materials on the current collector, smoothing the electrode materials by a blade etc. to adjust the thickness, then forming it by a press apparatus, the method of filling the electrode materials into a mold and pressing the mold to shape them, etc. Among these press forming methods, roll press forming is preferable.

The temperature at the time of forming is usually 0 to 200° C. It is preferably higher than the melting point or glass transition temperature of the binder, more preferably 20° C. or more higher than the melting point or glass transition temperature. The roll press forming is performed at a forming speed of usually 0.1 to 20 m/min, preferably 1 to 10 m/min. The faster the forming speed, the lower the obtained polarizable electrode in density, so by adjusting the forming speed, it is possible to adjust the obtained polarizable electrode in density. Further, the press line pressure between the rolls is usually 0.2 to 30 kN/cm, preferably 0.5 to 10 kN/cm. The higher the press line pressure, the higher the obtained polarizable electrode in density, so by adjusting the press line pressure, it is possible to adjust the obtained polarizable electrode in density.

To eliminate the variation in thickness of the shaped polarizable electrode and adjust the density of the polarizable electrode, it is possible to press it again later in accordance with need. The method of this later pressing is generally pressing by rolls. In the roll press step, two cylindrical rolls are arranged in parallel above and below each other across a narrow distance, are made to rotate in opposite directions, and press the polarizable electrode between them. The rolls may be heated, cooled, or otherwise adjusted in temperature.

(Composite Particles and their Methods of Production)

When using dry forming to produce the polarizable electrode, it is preferable to form it using composite particles comprised of an electrode active substance and conductive material bonded by a binder. The composite particles are produced by granulation using an electrode active substance, binder, conductive material, and other ingredients added in accordance with need.

The composite particles are preferably substantially spherical in shape. That is, when the short axis length of the composite particles is Lₛ, the long axis length is Lₗ, Lₐ=(Lₛ+Lₗ)/2, and the value of (1−(Lₗ−Lₛ)/Lₐ)×100 is made the sphericity (%), the sphericity is preferably 80% or more, more preferably 90% or more. The short axis length Lₐ and long axis length Lₗ are values measured from a transmission type electron microscope image.

The composite particles have a volume average particle size of usually 10 to 100 μm, preferably 20 to 80 μm, more preferably 30 to 60 μm in range. The volume average particle size can be measured using a laser diffraction particle size distribution measurement apparatus. The larger the composite particles in volume average particle size, the smaller the obtained polarizable electrode in density, so by suitably adjusting the composite particles used in particle size, it is possible to obtain a polarizable electrode having a desired density.

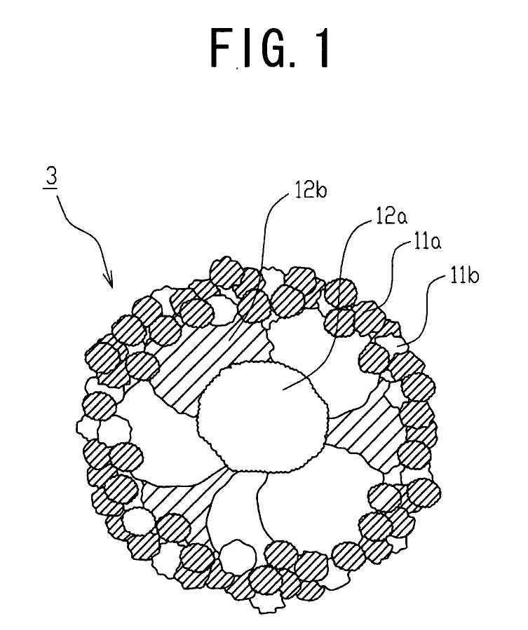

FIG. 1 is a conceptual view of the cross-section of a composite particle suitable for the present invention. Each composite particle 3 is comprised of an outer layer part and an inner layer part. The outer layer part and the inner layer part are comprised of electrode active substances and conductive materials bonded by a dispersion type binder. The electrode active substance 11a and conductive material 11b forming the outer layer part have volume average particle sizes smaller than the volume average particle sizes of the electrode active substance 12a and conductive material 12b forming the inner layer part.

The outer layer part of the composite particle is formed by bonding the electrode active substance and/or conductive material with relatively small average particle sizes. For this reason, it forms a dense layer with no voids. On the other hand, the inner layer part of the composite particle is formed by bonding the electrode active substance and/or conductive material with relatively large particle sizes. Since formed by materials with relatively large average particle sizes, this becomes a layer with numerous voids between the electrode active substance and/or conductive material.

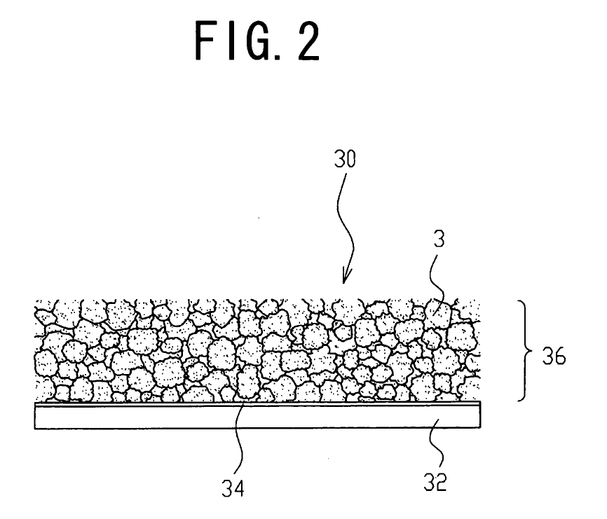

If using composite particles 3 with a dense outer layer part and with an inner layer part with numerous voids in this way, when forming a polarizable electrode by press forming etc., the composite particles will not become crushed, so a polarizable electrode 30 maintaining the shape of the composite particles 3 such as shown in FIG. 2 is obtained. Note that, FIG. 2 shows the configuration of an electrode 36 formed with a layer of the later mentioned conductive adhesive 34 on the surface of the current collector 32 and formed with the polarizable electrode 30 over that.

If the shapes of the composite particles are maintained, the channels of the electrolytic solution are secured between the particles, so the electrolytic solution quickly permeates to the inside of the polarizable electrode and the obtained electric double layer capacitor becomes lower in internal resistance. Here, if jointly using the small size electrode active substance and large size electrode active substance, it is possible to adjust the ratio of the outer layer part and inner layer part and density of the composite particles by the mixture ratio and possible to adjust the obtained polarizable electrode in density.

Further, in the above way, if using as the conductive material one with a volume average particle size smaller than the electrode active substance, the conductive material is mostly distributed at the outer layer parts of the composite particles while the electrode active substance is mostly distributed at the inner layer parts of the composite particles. By having the conductive material mostly distributed at the outer layer parts, the surfaces of the composite particles are believed to become higher in conductivity. When forming the polarizable electrodes, the composite particles contact each other at their surface, so it is believed that the electricity passes more easily and the resistance becomes lower. Further, since there are many voids communicating with the electrode active substance distributed in a large amount at the inner layer parts, it is believed that the permeability of the electrolytic solution is good. Therefore, it is deduced that the capacity becomes higher.

The composite particles used in the present invention are not particularly limited by method of production, but crush-resistant composite particles can be easily obtained by the following two methods of production.

The first method of production has a step of obtaining a slurry A containing an electrode active substance, conductive material, binder, and dispersant, a step of spray drying the slurry A for spray granulation, and a step of heat treatment as necessary.

With this method, the above ingredients are dispersed or dissolved in a solvent and the electrode active substance, conductive material, binder, and, if necessary, a dispersant and other additives are dispersed or dissolved to obtain the slurry A.

The solvent used for obtaining the slurry A is not particularly limited, but when using the dispersant, a solvent able to dissolve the dispersant is suitably used. Specifically, usually water is used, but it is also possible to use an organic solvent. As the organic solvent, for example, methyl alcohol, ethyl alcohol, propyl alcohol, and other alkyl alcohols; acetone, methyl ethyl ketone, and other alkyl ketones; tetrahydrofuran, dioxane, diglyme, and other ethers; diethyl formamide, dimethyl acetoamide, N-methyl-2-pyrrolidone (hereinafter sometimes referred to as “NMP”), dimethyl imidazolizinone, or other amides; dimethyl sulfoxide, sulphorane, and other sulfur-based solvents; etc. may be mentioned, but alcohols are preferable. It jointly using water and an organic solvent lower in boiling point than water, it is possible to increase the drying speed at the time of spray drying. Further, the dispersability of a binder or the solubility of the dispersant change, so the slurry A can be adjusted in viscosity or fluidity and the polarizable electrode can be adjusted in density by the amount or type of the solvent. The higher the slurry A in viscosity, the higher the obtained composite particles in density and therefore the higher the obtained polarizable electrode in density.

The amount of the solvent used when preparing the slurry A is an amount giving a solids concentration of the slurry A of usually 1 to 50 wt %, preferably 5 to 50 wt %, more preferably 10 to 30 wt % in range. By adjusting the solids concentration, it is possible to adjust the slurry A in viscosity, so it is possible to adjust the density of the composite particles and the density of the polarizable electrodes.

The method or routine for dispersing or dissolving the electrode active substance, conductive material, binder, dispersant, and other additives in the solvent is not particularly limited. For example, the method of adding to the solvent and mixing an electrode active substance, conductive material, binder, and dispersant, the method of dissolving a dispersant in the solvent, then adding and mixing a binder dispersed in a solvent (for example, latex) and finally adding and mixing an electrode active substance and conductive material, the method of adding and mixing an electrode active substance and conductive material to a binder dispersed in a solvent and adding a dispersant dissolved in a solvent to this, etc. may be mentioned. As the means for mixing, for example, a ball mill, sand mill, pigment disperser, kneader, ultrasonic disperser, homogenizer, planetary mixer, or other mixing equipment may be mentioned. The mixing is usually performed at a range of room temperature to 80° C. for 10 minutes to several hours.

Next, the slurry A is granulated by the spray drying method. The spray drying method is the method of spraying the slurry A into hot air for drying it. As a typical example of an apparatus using spray drying, an atomizer may be mentioned. There are two types of atomizers: the rotary disk type and the pressure type. The rotary disk type introduces the slurry at the substantial center of a disk rotating at a high speed and uses the centrifugal force of the disk to spin off the slurry to the outside of the disk and thereby atomize it to dry it. The rotational speed of the disk depends on the size of the disk, but usually is 5,000 to 30,000 rpm, preferably 15,000 to 30,000 rpm. It is possible to use the rotational speed of the disk to adjust the size of the composite particles and the density of the polarizable electrode. That is, the larger the rotational speed, the smaller the composite particles obtained in size, so the larger the density of the polarizable electrodes obtained using these composite particles. On the other hand, the pressure type is a type pressing the slurry A and ejecting it from a nozzle in a mist state to dry it.

The temperature of the sprayed slurry A is usually room temperature, but the slurry may also be warmed to room temperature or more. The hot air temperature at the time of spray drying is usually 80 to 250° C., preferably 100 to 200° C. In the spray drying method, the method of blowing in the hot air is not particularly limited. For example, the method where the hot air and the spraying direction are parallel to the horizontal direction, the method of being sprayed at the top of the drying tower and descending together with the hot air, the method where the sprayed drops and hot air come into contact by convection, the method where the sprayed drops first flow in parallel to the hot air then drop by gravity and come into contact by convection, etc. may be mentioned.

By the above method, composite particles are obtained. Further, heat treatment may also be performed to cause the surface of the composite particles to harden. The heat treatment temperature is usually 80 to 300° C.

The second method of production has a step of obtaining a slurry B containing a conductive material, binder, dispersant, and other additives, a step of causing the electrode active substance to flow in a tank, spraying the slurry B there, and fluid granulating it, a step of tumble granulating the particles obtained in the fluid granulation step, and if necessary a step of heat treatment.

With this method, a slurry B containing a conductive material, binder, dispersant, and other additives is obtained. As the solvent used for obtaining the slurry B, solvents the same as those mentioned in the first method of production can be mentioned.

The amount of the solvent used when preparing the slurry B is an amount giving a solids concentration of the slurry B of usually 1 to 50 wt %, preferably 5 to 50 wt %, more preferably 10 to 30 wt % in range. When the amount of the solvent is in this range, the binder uniformly disperses, so this is preferable. Further, in the same way as the above first method of production, it is possible to adjust the solids concentration to adjust the density of the obtained composite particles and density of the polarizable electrode.

Next, the electrode active substance is made to flow in the tank and the slurry B is sprayed there for fluid granulation. As the method for fluid granulation in the tank, one using a fluid bed, one using a modified fluid bed, one using a spouted bed, etc. may be mentioned. The method using a fluid bed uses hot air to make the electrode active substance flow and sprays the slurry B from the sprayer etc. to this for agglomeration granulation. The method using a modified fluid bed is similar to the fluid bed method, but gives a circulating flow in the layer and utilizes the classification effect to discharge granules grown relatively large. Further, the method using a spouted bed utilizes the characteristics of a spouted bed to deposit the slurry B on a rough electrode active substance from a sprayer etc. and simultaneously drying and granulating it. As the method of production of the present invention, one using the fluid bed or modified fluid bed method among these three methods is preferable. The temperature of the sprayed slurry B is usually room temperature, but the slurry may also be warmed to room temperature or more. The temperature of the hot air used for the fluidization is usually 80 to 300° C., preferably 100 to 200° C.

Next, the particles obtained by the fluid granulation step are tumble granulated. Tumble granulation includes the rotating disk type, rotating cylinder type, rotating frustoconical type, or other types. The rotating disk type sprays a dispersion type binder in accordance with need on particles supplied to a slanted rotating dish to generate agglomerated granules and utilizes the classification effect of the rotating dish to discharge granules grown relatively large. The rotating cylinder type is the type supplying moistened particles to a slanted rotating cylinder, making this tumble in the cylinder, and in accordance with need spraying the binder or the slurry B to obtain agglomerated granules. The rotating frustoconical type is similar in operation to the rotating cylinder type, but utilizes the classification effect of the agglomerated granules due to the frustoconical shape and discharges granules grown relatively large. The temperature at the time of tumble granulation is not particularly limited, but to remove the solvent forming the slurry, it is usually 80 to 300° C., preferably 100 to 200° C. Further, in accordance with need, the composite particles are heat treated to cause them to harden at their surfaces. The heat treatment temperature is usually 80 to 300° C.

Due to the above method of production, composite particles containing an electrode active substance, conductive material, binder, and dispersant is obtained. The composite particles are comprised of the electrode active substance and conductive material bonded by the binder. The outer layer parts of the composite particles are formed by the electrode active substance and/or conductive material with relatively small volume average particle sizes bonded together, while the inner layer parts of the composite particles are formed by the electrode active substance and/or conductive material with relatively large volume average particle sizes bonded together.

(Wet Forming)

As the wet forming method, the coating method can be preferably used. The coating method is the method of dissolving or dispersing an electrode active substance, binder, and other optional ingredients in a solvent to obtain a slurry C and coats and dries this on a later explained current collector to form a polarizable electrode on a current collector. As the solvent used for obtaining the slurry C, solvents the same as those illustrated as able to be used for preparation of the above slurry A can be mentioned. As the solvent, water is most preferable. Further, among the organic solvents, N-methyl-2-pyrrolidone is preferable.

The method of coating the slurry C on the current collector is not particularly limited. For example, the doctor blade method, dip method, reverse roll method, direct roll method, gravia method, extrusion method, brushing method, or other methods may be mentioned. The slurry C differs in viscosity according to the type of the coating machine or the shape of the coating line, but usually is 100 to 100,000 mPa·s, preferably 1,000 to 50,000 mPa·s, more preferably 5,000 to 20,000 mPa·s. The higher the slurry C in viscosity, the higher the obtained polarizable electrode tends to be in density, so it is possible to use the viscosity of the slurry C to adjust the density of the polarizable electrode.

The amount of the slurry C coated is also not particularly limited, but the obtained polarizable electrode usually has a thickness of 5 to 5,000 μm, preferably 10 to 2,000 μm. As the drying method, for example, drying by warm air, hot air, and low humidity air, vacuum drying, drying by irradiation by (far) infrared rays, electron beams, etc. may be mentioned. The drying temperature is usually 150 to 250° C. The faster the drying speed, the lower the polarizable electrode in density, so by adjusting the temperature or degree of pressure reduction at the time of drying, it is possible to obtain a polarizable electrode having the desired density. Further, by press forming after drying, it is possible to adjust the density of the polarizable electrode. As the press forming method, mold pressing, roll pressing, or another method may be mentioned.

(Electrodes)

The polarizable electrode is usually used laminated with the current collector to form an electrode. According to this coating method, the current collector has the polarizable electrode formed over it to obtain an integral electrode. Further, when forming a polarizable electrode by roll press forming, it is also possible to simultaneously feed the current collector to the rolls together with the feed of the electrode material to laminate the polarizable electrode on the current collector.

As the material for the current collector, for example, a metal, carbon, conductive polymer, etc. may be used. Preferably, a metal is used. As the metal for the current collector, usually aluminum, platinum, nickel, tantalum, titanium, stainless steel, or another alloy etc. is used. Among these, from the viewpoint of the conductivity and withstand voltage, it is preferable to use aluminum or an aluminum alloy. Further, when a high withstand voltage is demanded, it is preferable to use the high purity aluminum disclosed in Japanese Patent Publication (A) No. 2001-176757. Specifically, aluminum of a purity of 99.99% or more is preferable. Further, the content of the copper is preferably 150 ppm or less. The current collector is a film or sheet in shape. Its thickness is suitably selected in accordance with the object of use, but usually is 1 to 200 μm, preferably 5 to 100 μm, more preferably 10 to 50 μm. The sheet-like current collector may also have pores. That is, the sheet-like current collector may have the shape of expanded metal, punched metal, a mesh, etc. If a sheet-like current collector having pores is used, the capacity per volume of the obtained electrode can be raised. The ratio of the pores in the case where the sheet-like current collector has pores is preferably 10 to 79 area %, more preferably 20 to 60 area %.

(Conductive Adhesive)

The current collector used may be one formed with a conductive adhesive on its surface. The conductive adhesive has at least a conductive material and binder. The conductive material, binder, and dispersant added as necessary are kneaded in water or an organic solvent to prepare this. The obtained conductive adhesive is coated and dried on the current collector to form a layer of a conductive adhesive. The polarizable electrode is laminated with the current collector through a layer of a conductive adhesive to improve the bondability between the polarizable electrode and current collector and contribute to the reduction of the internal resistance.

As the conductive material, binder, and dispersant used in the conductive adhesive, it is possible to use any of those illustrated as ingredients used for the polarizable electrodes. As the amounts of the ingredients, the binder is preferably used in an amount, based on the dried weight, of 5 to 20 parts by weight with respect to 100 parts by mass of the conductive material and the dispersant in an amount, based on the dried weight, of 1 to 5 parts by weight. If the amount of the binder is too small, the bond between the polarizable electrode and current collector is sometimes insufficient. On the other hand, if the amount of the binder is too great, the dispersion of the conductive material becomes insufficient and the internal resistance sometimes becomes larger. Further, if the amount of the dispersant is too small, the dispersion of the conductive material sometimes becomes insufficient. On the other hand, if the amount of the dispersant is too great, the conductive material is covered by the dispersant and the internal resistance sometimes becomes greater.

The method of coating the conductive material on the current collector is not particularly limited. For example, it may be coated by the doctor blade method, dip method, reverse roll method, direct roll method, gravia method, extrusion method, brushing, etc. The amount coated is not particularly limited. The layer of the conductive adhesive formed after drying is adjusted in thickness to usually 0.5 to 10 μm, preferably 2 to 7 μm.

(Separator)

The capacitor element in the present invention has two such electrodes. These are made to face each other across a separator. The separator used for the electric double layer capacitor of the present invention is not particularly limited so long as it can insulate the polarizable electrodes from each other and can pass the cations and anions of the ionic liquid. Specifically, a microporous film or nonwoven fabric made of polyethylene, polypropylene, or another polyolefin, rayon, or glass fiber, a porous film mainly made of pulp, generally called “electrolytic capacitor paper”, etc. may be used. The separator is arranged between the electrodes so that the pair of polarizable electrodes face each other and a capacitor element is obtained.

(Electrolytic Solution)

The electric double layer capacitor of the present invention contains an ionic liquid as an electrolytic solution. The ionic liquid is a liquid with cations and anions present in an ion coupled state at ordinary temperature. As cation ions, dimethyl imidazolium ions, ethylmethyl imidazolium ions, diethyl imidazolium ions, and other alkyl imidazolium ions; propyl pyridinium ions, isopropyl pyridinium ions, butyl pyridinium ions, and other alkyl pyridinium ions; tetraethyl ammonium ions, tributylmethyl ammonium ions, hexyltrimethyl ammonium ions, diethylmethyl (2-methoxyethyl) ammonium ions, and other alkyl ammonium ions; tetramethyl phosphonium ions, tetrabutyl phosphonium ions, and other alkyl phosphonium ions; etc. may be mentioned. Among these, alkyl imidazolium ions are preferable, while ethylmethyl imidazolium can prevent corrosion of the current collector or sealing part, so is more preferable.

As anions, tetrafluoroborate ions, hexafluorophosphate ions, chlorine ions, bromine ions, iodine ions, trifluoromethane sulfonic acid ions, arsenic hexafluoride ions, nitric acid ions, perchloric acid ions, and bistrifluoromethane sulfoxide ions, etc. may be mentioned. These ionic liquids may be used alone or may be used in combinations of two or more types.

The electrolytic solution may also be a mixed solution of an ionic liquid and other organic solvents. The organic solvent in general is not particularly limited so long as it is used as a solvent of the electrolytic solution. Specifically, propylene carbonate, ethylene carbonate, butylene carbonate, or other carbonates; γ-butyrolactone and other lactones; sulphoranes; and acetonitrile and other nitriles may be mentioned. These may be used alone or as mixed solvents of two or more types. Among these, carbonates are preferable. If using a mixed solution of an ionic liquid and other organic solvents, it is possible to lower the electrolytic solution in viscosity, so the permeability of the electrolytic solution into the electrode can be raised. The electrolytic solution has a viscosity of preferably 5 to 50 mPa·s, more preferably 10 to 40 mPa·s. On the other hand, if the amount of the ionic liquid is too small, the electric double layer capacitor falls in capacity, so the amount of the ionic liquid in the entire electrolytic solution is usually 5 wt % or more, preferably 20 wt % or more.

Further, it is also possible to dissolve an electrolyte solid at ordinary temperature in an electrolytic solution in a range not detracting from the effects of the present invention. As an electrolyte solid at ordinary temperature, tetraethyl ammonium tetrafluoroborate, triethyl monomethyl ammonium tetrafluoroborate, tetraethyl ammonium hexafluorophosphate, etc. may be mentioned.

The above capacitor element was impregnated with an electrolytic solution to obtain the electric double layer capacitor of the present invention. Specifically, the capacitor element is rolled, stacked, bent, etc. as necessary to be placed in a container, then the container is filled with the electrolytic solution and sealed. Further, it is also possible to place a capacitor element impregnated with the electrolytic solution in advance into a container. As the container, it is possible to use a button type, cylinder type, rectangular prism type, or other known type. The polarizable electrodes used in the present invention have a high permeability of the electrolytic solution, so even if impregnating the electrolytic solution sufficiently under ordinary pressure, the time required for permeation after impregnating the electrolytic solution under reduced pressure may be shortened.

The electric double layer capacitor of the present invention uses an ionic liquid as an electrolyte, so the capacity is large and the electrolytic solution permeability of the polarizable electrodes is high, so the internal resistance is small and the productivity is superior.

Note that the disclosure of Japanese Patent Publication (A) No. 2001-176757 cited in the “Best Mode for Carrying Out the Invention” is incorporated as part of the description of the present Description insofar as the domestic laws and regulations of the designated countries designated in this international application or elected countries elected by it allow. Further, the present invention is related to the content included in Japanese Patent Application No. 2005-366840 filed on Dec. 20, 2005. All of its disclosure is clearly incorporated here by reference.

### EXAMPLES

Below, examples and comparative examples will be used to explain the present invention in further detail, but the present invention is not limited to these examples. Note that the parts and % in the examples and comparative examples are based on weight unless otherwise indicated. The examples and comparative examples were measured for their properties in accordance with the following methods.

(1) Particle Size

The electrode active substance and composite particles were measured for volume average particle size by a laser diffraction type particle size distribution measurement apparatus (SALD-2000; made by Shimadzu Seisakusho).

(2) Electrolytic Solution Permeability

The electrolytic solution permeability of the electrodes was evaluated by dropping 20 μl of an electrolytic solution on an electrode cut to 2 cm×2 cm and measuring the time until the drops of the electrolytic solution could no longer be seen on the electrode surface. The shorter this time, the better the electrode in electrolytic solution permeability. Here, as the electrolytic solution, an ionic liquid ethylmethyl imidazolium tetrafluoroborate (EMIBF₄) alone and a mixed solution of EMIBF₄ and propylene carbonate (PC) (mixed ratio, by volume ratio, of EMIBF₄:PC=1:1) were used. These electrolytic solutions had viscosities at 25° C., measured using a B-type viscometer by a rotor No. 1 and speed of 60 rpm, of respectively 42 mPa·s and 13 mPa·s.

(3) Electrical Characteristics

The button cell shaped electric double layer capacitors prepared in the examples and comparative examples were measured for electrostatic capacity and internal resistance after allowing the prepared button cells to stand for 24 hours, then charging and discharging them. Here, the charging was started at a 10 mA constant current. When the voltage reached 2.7V, that voltage was held for constant voltage charging. When the charging current fell to 0.5 mA, the charging was ended. Further, the discharge was performed right after the end of the charging by a constant current of 10 mA until reaching 0V. The electrostatic capacity was calculated using the energy conversion method at the time of discharging as the electrostatic capacity per weight of active substance used for the electric double layer capacitor. The internal resistance was calculated from the voltage drop right after discharge.

### Example 1

An electrode active substance comprised of an activated carbon powder of a steam activated carbon made of phenolic resin with a volume average particle size of 15 μm (RP-20; made by Kuraray Chemical) in 50 parts and an activated carbon powder of a steam activated carbon made of palm shells with a volume average particle size of 15 μm (YP-17; made by Kuraray Chemical) 50 parts, a dispersant comprised of a 1.5% aqueous solution of carboxymethyl cellulose (DN-800H; made by Daicel Chemical Industries) in a solids content of 1.4 parts, a conductive material comprised of acetylene black (Denka Black Powder; made by Denki Kagaku Kogyo) in 5 parts, a binder comprised of a 40% aqueous dispersion of a cross-linkable acrylate polymer with a number average particle size of 0.12 μm and a glass transition temperature of −5° C. in a solids content of 5.6 parts, and ion exchanged water were mixed to give a solids concentration of 20% to prepare a slurry.

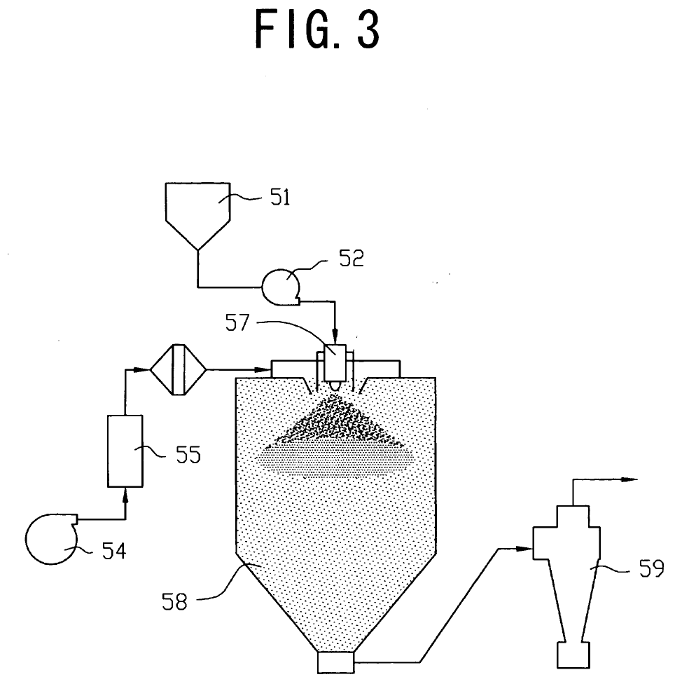

Next, this slurry was supplied to a hopper 51 of a spray drier such as shown in FIG. 3 (made by Ohkawara Kakohki), was fed by a pump 52 to a nozzle 57 at the top of the tower, then was sprayed from the nozzle to the inside of the drying tower 58. Simultaneously, 150° C. hot air was supplied from a pump 54 through a heat exchanger 55 from the sides of the nozzle 57 to the drying tower 58. Composite particles were taken out from the drying tower 58 by a suction machine 59. Due to this, spherical composite particles with a volume average particle size of 32 μm and a sphericity of 93% was obtained.

The obtained composite particles were supplied to the rolls (roll temperature 100° C., press line pressure 3.9 N/cm) of a roll press machine (hand push rough surface hot rolls; made by Hirano Giken) and molded into a sheet shape at a forming speed of 5 m/min to obtain a polarizable electrode of a thickness of 500 μm. This polarizable electrode had a density (electrode density) of 0.55 g/cm³.

Separate from this, an aluminum foil of a thickness of 20 μm was coated with a current collector paint (Varniphite #523-3; made by Nippon Graphite Industries) and dried to form a conductive adhesive layer and obtain a current collector. The obtained polarizable electrode was laminated with the current collector, then the laminate was punched to disks of a diameter of 12 mm to obtain electrodes.

The electrodes and a rayon nonwoven fabric used as a separator were dipped in the electrolytic solution at room temperature for 2 hours, then the two electrodes were arranged so as to face each other across the separator with the polarizable electrodes at the insides and so that the electrodes do not electrically contact each other to thereby prepare a button cell shaped electric double layer capacitor. For the electrolytic solution, a mixture of ethylmethyl imidazolium tetrafluoroborate and propylene carbonate in a volume ratio of 1:1 was used. The electrodes and electric double layer capacitor were measured for their properties. The results are shown in Table 1.

### Examples 2 and 3

Except for using as the electrode active substances the ones shown in Table 1, the same procedure was followed as in Example 1 to prepare a polarizable electrode, electrode, and electric double layer capacitor. The obtained polarizable electrode, electrode, and electric double layer capacitor were measured for their properties. The results are shown in Table 1.

### Comparative Example 1

The polarizable electrode obtained in Example 3 was further pressed by calendar rolls to obtain a thickness 475 μm polarizable electrode. This polarizable electrode was used in the same way as Example 1 to prepare an electrode and electric double layer capacitor. The obtained polarizable electrode, electrode, and electric double layer capacitor were measured for their properties. The results are shown in Table 1.

TABLE 1

| | | | | Comp. |
|---|---|---|---|---|
| | Ex. 1 | Ex. 2 | Ex. 3 | Ex. 1 |
| Amount of activated carbon | | | | |
| powder (parts) | | | | |
| RP-20, average particle size | | 30 | 100 | 100 |
| 5 μm | | | | |
| RP-20, average particle size | 50 | 70 | | |
| 15 μm | | | | |
| YP-17, average particle size | 50 | | | |
| 15 μm | | | | |
| Characteristics of | | | | |
| polarizable electrodes | | | | |
| Current density (g/cm³) | 0.55 | 0.56 | 0.57 | 0.61 |
| Polarizable electrode | 500 | 500 | 500 | 475 |
| thickness (μm) | | | | |
| Electrolytic solution | | | | |
| permeability (permeation | | | | |
| time) | | | | |
| EMIBF₄ | 3 min, | 11 min, | 30 min | 1 h or |
| | 20 sec | 33 sec | | more |
| EMIBF₄/PC = 1/1 | 1 min, | 1 min, | 3 min, | 20 min or |
| | 40 sec | 20 sec | 55 sec | more |
| Electrical characteristics | | | | |
| Electrostatic capacity per | 25 | 26 | 27 | 26 |
| weight of activated carbon | | | | |
| (F/g) | | | | |
| Capacitor internal resistance | 14.0 | 15.5 | 16.0 | 17.0 |
| (Ω) | | | | |

### Examples 4 to 6

Except for making the conditions of the roll forming each of the conditions shown in Table 2, the same procedure was followed as in Example 1 to prepare a polarizable electrode, electrode, and electric double layer capacitor. The obtained polarizable electrode, electrode, and electric double layer capacitor were measured for their properties. The results are shown in Table 2.

### Examples 7 to 10

Except for making the conditions of the roll press forming each of the conditions shown in Table 2, the same procedure was followed as in Example 2 to prepare a polarizable electrode, electrode, and electric double layer capacitor. The obtained polarizable electrode, electrode, and electric double layer capacitor were measured for their properties. The results are shown in Table 2.

### Examples 11 to 13

Except for making the conditions of the roll press forming each of the conditions shown in Table 2, the same procedure was followed as in Example 3 to prepare a polarizable electrode, electrode, and electric double layer capacitor. The obtained polarizable electrode, electrode, and electric double layer capacitor were measured for their properties. The results are shown in Table 2.

TABLE 2

| | Ex. 4 | Ex. 5 | Ex. 6 | Ex. 7 | Ex. 8 | Ex. 9 | Ex. 10 | Ex. 11 | Ex. 12 | Ex. 13 |
|---|---|---|---|---|---|---|---|---|---|---|
| Amount of activated carbon | | | | | | | | | | |
| powder (parts) | | | | | | | | | | |
| RP-20, average particle size 5 μm | | | | 30 | 30 | 30 | 30 | 100 | 100 | 100 |
| RP-20, average particle size 15 μm | 50 | 50 | 50 | 70 | 70 | 70 | 70 | | | |
| YP-17, average particle size 15 μm | 50 | 50 | 50 | | | | | | | |
| Forming speed (m/min) | 10 | 10 | 5 | 10 | 10 | 5 | 5 | 10 | 10 | 10 |
| Press line pressure (kN/cm) | 0.5 | 2.4 | 6.0 | 1.5 | 2.1 | 4.5 | 7.5 | 1.5 | 2.1 | 3.6 |
| Characteristics of polarizable | | | | | | | | | | |
| electrodes | | | | | | | | | | |
| Electrode density (g/cm³) | 0.43 | 0.50 | 0.58 | 0.44 | 0.50 | 0.57 | 0.59 | 0.46 | 0.50 | 0.55 |
| Polarizable electrode thickness | 600 | 550 | 430 | 580 | 530 | 420 | 390 | 550 | 530 | 500 |
| (μm) | | | | | | | | | | |
| Electrolytic solution | | | | | | | | | | |
| permeability (permeation time) | | | | | | | | | | |
| EMIBF₄ | 1 min | 1 min | 9 min | 1 min | 1 min | 17 min | 26 min | 1 min | 2 min | 22 min |
| | | 12 sec | 30 sec | 6 sec | 30 sec | 30 sec | | 12 sec | | |
| Electrical characteristics | | | | | | | | | | |
| Electrostatic capacity per | 26 | 26 | 25 | 27 | 27 | 27 | 27 | 27 | 27 | 26 |
| weight of activated carbon (F/g) | | | | | | | | | | |
| Capacitor internal resistance | 0.5 | 0.6 | 0.7 | 0.7 | 0.9 | 1.1 | 1.7 | 0.7 | 0.9 | 1.2 |
| (Ω) | | | | | | | | | | |

### Example 14

A conductive material comprised of acetylene black (Denka Black Powder; made by Denki Kagaku Kogyo) in 50 parts, a dispersant comprised of a 5% carboxymethyl cellulose aqueous solution (Cellogen 7A; made by Daiichi Kogyo Seiyaku) in 200 parts, and water in 50 parts were mixed to disperse using a planetary mixer and thereby obtain a solids concentration 20% conductive material dispersion. The conductive material dispersion in 30 parts, a 5% carboxymethyl cellulose aqueous solution (Cellogen 7A; made by Daiichi Kogyo Seiyaku) in 20 parts, an electrode active substance comprised of an activated carbon powder of steam activated carbon of a volume average particle size of 15 μm made from a phenolic resin (RP-20; made by Kuraray Chemical) in 50 parts an activated carbon powder of steam activated carbon of a volume average particle size of 15 μm made from palm shells (YP-17; made by Kuraray Chemical) in 50 parts, a binder of the same type as used in Example 1 in a solids content of 2 parts, and water were added and mixed by a planetary mixer to obtain a slurry of a total solids concentration of 36%.

This electrode composition was coated on the current collector, that is, aluminum foil of a thickness of 20 μm, using a doctor blade, then the coated film was dried to form a polarizable electrode of a thickness of 100 μm on the current collector to obtain an electrode. This electrode was used in the same way as Example 1 to prepare an electric double layer capacitor. The obtained polarizable electrode, electrode, and electric double layer capacitor were measured for their properties. The results are shown in Table 3. Note that the electrode density is found by cutting an electrode to 5 cm×5 cm, measuring its weight and thickness, and subtracting the weight and thickness of the current collector to calculate the density of the polarizable electrode.

### Example 15 and Comparative Example 2

Except for using as the electrode active substance the substances shown in Table 3, the same procedure was followed as in Example 14 to prepare an electrode and electric double layer capacitor. The obtained polarizable electrode, electrode, and electric double layer capacitor were measured for their properties. The results are shown in Table 3.

### Comparative Example 3

The electrode obtained in Example 15 was further pressed by calendar rolls to obtain an electrode of a thickness of 97 μm for a polarizable electrode. This electrode was used in the same way as in Example 1 to prepare an electric double layer capacitor. The obtained polarizable electrode, electrode, and electric double layer capacitor were measured for their properties. The results are shown in Table 3.

TABLE 3

| | | | Comp. | Comp. |
|---|---|---|---|---|
| | Ex. 14 | Ex. 15 | Ex. 2 | Ex. 3 |
| Amount of activated carbon | | | | |
| powder (parts) | | | | |
| RP-20, average particle size | | 30 | 100 | 30 |
| 5 μm | | | | |
| RP-20, average particle size | 50 | 70 | | 70 |
| 15 μm | | | | |
| YP-17, average particle size | 50 | | | |
| 15 μm | | | | |
| Characteristics of | | | | |
| polarizable electrodes | | | | |
| Current density (g/cm³) | 0.50 | 0.54 | 0.61 | 0.60 |
| Polarizable electrode | 100 | 100 | 100 | 97 |
| thickness (μm) | | | | |
| Electrolytic solution | | | | |
| permeability (permeation | | | | |
| time) | | | | |
| EMIBF₄ | 20 min | 33 min | 1 h or | 1 h or |
| | | | more | more |
| EMIBF₄/PC = 1/1 | 5 min | 10 min | 20 min or | 20 min or |
| | | | more | more |
| Electrical properties | | | | |
| Electrostatic capacity per | 25 | 26 | 27 | 26 |
| weight activated carbon (F/g) | | | | |
| Capacitor internal resistance | 7.5 | 8.5 | 9.0 | 8.8 |
| (Ω) | | | | |

As clear from the above examples and comparative examples, the electric double layer capacitor of the present invention is superior in the permeability of the electrolytic solution in the electrodes used, so can be produced with a small internal resistance and high productivity.

### INDUSTRIAL APPLICABILITY

The electric double layer capacitor of the present invention is particularly suitable for applications requiring thick polarizable electrodes and can be suitably used for backup power supplies for memories of PCs, mobile phones, etc., power supplies for dealing with momentary power outages for PCs etc., electric vehicles or hybrid cars, solar power generated energy storage systems used together with solar cells, load leveling power supplies combined with batteries, and various other applications.

1. An electric double layer capacitor containing a capacitor element comprised of electrodes including a pair of polarizable electrodes facing each other across a separator and an electrolytic solution, wherein
at least one of said polarizable electrodes has a density of 0.40 to 0.59 g/cm³, and said electrolytic solution contains an ionic liquid.

2. The electric double layer capacitor as set forth in claim 1, wherein said polarizable electrodes are produced by using both a small size electrode active substance with a volume average particle size of 2 to 6 μm and a large size electrode active substance with a volume average particle size of 8 to 20 μm.

3. The electric double layer capacitor as set forth in claim 1, wherein said polarizable electrodes contain palm shell carbon as electrode active substances.

4. The electric double layer capacitor as set forth any one of claims 1 to 3, wherein said polarizable electrodes are comprised of an electrode active substance and conductive material bonded by a binder to form composite particles which are in turn bonded together.

5. The electric double layer capacitor as set forth in claim 4, wherein said composite particles are produced by a spray dry granulation method having a step of obtaining a slurry A containing an electrode active substance, conductive material, and binder and a step of spray drying the slurry A.

6. The electric double layer capacitor as set forth in claim 4, wherein said polarizable electrodes are produced by roll press forming said composite particles.

7. The electric double layer capacitor as set forth in claim 4, wherein said electrode is comprised of said polarizable electrode laminated with a current collector via a layer of a conductive adhesive.
